(19) United States
(12) Patent Application Publication
(10) Pub. No.: US 2026/0271114 A1
(43) Pub. Date: Sep. 10, 2026

(54) RELAY COMMUNICATION SIDELINK REESTABLISHMENT

(71) Applicant: Kyocera Corporation, Kyoto (JP)

(72) Inventors: Henry CHANG, San Diego, CA (US); Masato FUJISHIRO, Yokohama (JP)

(21) Appl. No.: 18/994,893

(22) PCT Filed: Aug. 1, 2023
(86) PCT No.: PCT/US2023/029209

§ 371 Date: Jan. 15, 2025

Related U.S. Application Data
(60) Provisional application No. 63/396,322, filed on Aug. 9, 2022.

(51) Int. Cl. H04W 76/19; H04L 1/1829; H04W 88/04; H04W 92/18

(52) U.S. Cl. CPC H04W 76/19; H04L 1/1829; H04W 88/04; H04W 92/18

(57) ABSTRACT

A first user equipment (UE) device communicating with a second UE device over a sidelink communication link through one or more relay UE devices sends a reestablishment message to establish an alternate communication path to the second UE device. The alternate communication path may be a direct PC5 link or a relay communication link through an alternate relay UE device. In some situations, the determination that the alternate communication path should be established is based on a notification received from the relay UE device.

### CLAIM OF PRIORITY

The present application claims priority to Provisional Application No. 63/396,322, entitled “U2U relaying Control Plane,” docket number TPRO 00376 US, filed Aug. 9, 2022, which is assigned to the assignee hereof and hereby expressly incorporated by reference in its entirety.

### FIELD

This invention generally relates to wireless communications and more particularly to relay communication sidelink reestablishment.

### BACKGROUND

Sidelink functionality allows a user equipment (UE) device to communicate directly with another UE device without utilizing a base station. Sidelink relaying functionality allows a remote user equipment (UE) device that is out-of-coverage (OoC) to connect with the gNB or base station via a relay UE device. Relay functionality allows one UE device to connect to another UE device over a relay communication link going through at least one relay UE. In some situations, the relay communication link may also go through one or more base stations or gNBs.

### SUMMARY

A first user equipment (UE) device communicating with a second UE device over a sidelink communication link through one or more relay UE devices sends a sidelink reestablishment message to establish an alternate communication path to the second UE device. The alternate communication path may be a direct PC5 link or a relay communication link through an alternate relay UE device. In some situations, the determination that the alternate communication path should be established is based on a notification received from the relay UE device.

### BRIEF DESCRIPTION OF THE DRAWINGS

FIG. 1 is a block diagram of an example of a system where a relay user equipment (UE) device is facilitating data communication between a first UE device and a second UE device over a U2U relay communication link and the first UE device 104 sends a reestablishment message.

FIG. 2 is a block diagram of an example of a base station (gNB) suitable for use as the gNB.

FIG. 3 is a block diagram of an example of a UE device suitable for use as each of the UE devices.

FIG. 4 is a message diagram of an example of reestablishment of a communication link between the first UE device and the second UE device.

FIG. 5 is a message diagram of an example of reestablishment of a communication link between the first UE device and the second UE device through an alternate relay UE device where the reestablishment message includes a direct communication request (DCR) message with a reestablishment indicator.

FIG. 6A is a message diagram of an example of reestablishment of a communication link between the first UE device and the second UE device through an alternate relay UE device where the reestablishment message includes a PC5-RRC reestablishment message.

FIG. 6B is a message diagram of an example of reestablishment of a communication link between the first UE device and the second UE device through an alternate relay UE device where the reestablishment message includes a PC5-S reestablishment message.

FIG. 7A is a message diagram of an example of reestablishment of a communication link between the first UE device and the second UE device through a direct PC5 link.

FIG. 7B is a message diagram of an example of reestablishment of a communication link between the first UE device and the second UE device through a direct PC5 link where an PC5-S reestablishment message is transmitted.

FIG. 8 is a message diagram of an example of reestablishment of a communication link between the first UE device and the second UE device through a direct PC5 link where the reestablishment message includes a direct communication request (DCR) message with a reestablishment indicator.

FIG. 9 is a message diagram of an example of relay Hybrid Automatic Repeat Request (HARQ) feedback where the relay UE device provides feedback for the first hop PC5 link and performs retransmissions over the second PC5 link in response to NACK feedback from the second UE device.

FIG. 10 is a message diagram of an example of relay HARQ feedback where the relay UE device provides feedback for the transmission over the second hop PC5 link via an RRC message in response to NACK feedback from the second UE device.

FIG. 11 is a message diagram of an example of relay HARQ feedback where the relay UE device provides feedback for the first hop PC5 link and declares a DTX in response to no HARQ feedback being received from the second UE device.

FIG. 12 is a message diagram of an example of relay HARQ feedback where the relay UE device provides feedback using for the second hop PC5 link using the HARQ process ID used for the transmission from the first UE device to the relay UE device.

FIG. 13 is a message diagram of an example where the relay UE device notifies the first UE device that the first hop PC5 link will be released.

### DETAILED DESCRIPTION

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D).

In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying, and the relay UE device establishes a communication path between the remote UE and a base station (gNB) or cell. In some situations, for example, the UE device may be out of the service area of the base station, and the relay UE device provides a communication link routed from such an out-of-coverage (OoC) UE device through the relay UE device to the base station. Where the destination device is another UE device (target UE device, peer UE device, destination UE device, etc.), the relaying functionality is typically referred to as UE-to-UE (U2U) relaying.

Thus, sidelink relaying functionality allows a remote UE that is out-of-coverage (OoC) to connect with the gNB or base station via a relay UE device. With UE-to-Network (U2N) relaying, the relay UE needs to be in coverage of a cell and connected to the gNB. The relayed connection from the remote UE device to the base station (gNB) includes (1) a PC5 link (sidelink) between the remote UE device and the relay UE device, and optionally (2) a direct communication link (e.g., Uu link) between the relay UE device and the gNB.

Since the UE devices are not necessarily stationary, it is possible that the relative positions between the UE devices changes and that one or more links may deteriorate. Where a first UE device is communicating through a relay UE device with a second UE device, the first hop PC5 link between the first UE device and the relay device and/or the second hop PC5 link between the relay UE device and the second UE device may deteriorate, experience a radio link failure (RLF), or otherwise fall below an acceptable quality threshold to continue communication over the relay link. With conventional systems, a new communication link must be established in these situations. In other words, conventional systems do not allow for reestablishing the communication link without establishing new communication links where all previous information and data are lost. As a result, conventional systems suffer from inefficient and time-consuming techniques for continuing data communication between two UE devices communicating over a relay communication link that can longer be maintained.

In accordance with the examples discussed herein, however, a UE device sends a sidelink reestablishment message in response to determining that the current communication link over U2U relay link to another UE device should be reestablished over an alternate communication path. As a result of the sidelink reestablishment message, an alternate communication path (either direct PC5 or a U2U relay link) is established to reestablish the communication link where the context of each UE device is maintained at its peer UE device and applied to the reestablished communication link. In some examples, the UE device may determine that the PC5 link (first hop) to the relay UE device has been degraded, experienced an RLF, or otherwise has become unsuitable for communication and that the communication link should be reestablished. In other examples, the first UE device receives a notification from the relay UE device indicating that the quality of the communication link has been degraded, experienced an RLF, or otherwise has become unsuitable for communication. In some situations, the notification is related to the PC5 link (second hop) from the relay UE device to the second UE device. In other situations, the notification is related to PC5 link (first hop) from the relay UE device to the first UE device. Relay Hybrid Automatic Repeat Request (HARQ) feedback relating to the PC5 first hop is an example of such a situation. In still other situations, the notification may be an application level message indicating requirements of the communication exceed the capabilities of the current communication link. Such a notification may be triggered by a change in requirements or by a change in capabilities.

Although the techniques discussed herein may be applied to various types of systems and communication specifications, the devices of the example operate in accordance with at least one revision of the 3^{rd} Generation Partnership Project (3GPP) New Radio (NR) V2X communication specification. The techniques discussed herein, therefore, may be adopted by one or more future revisions of communication specifications, although the techniques may be applied to other communication specifications where sidelink or D2D and relay functionality are employed. More specifically, the techniques may be applied to current and future releases of 3GPP NR specifications. For example, the techniques may also be applied to 3GPP NR (3GPP Rel-17) and 3GPP Rel-18 .

Although the different examples described herein may be discussed separately, any of the features of any of the examples may be added to, omitted from, or combined with any other example. Similarly, any of the features of any of the examples may be performed in parallel or performed in a different manner/order than that described or shown herein.

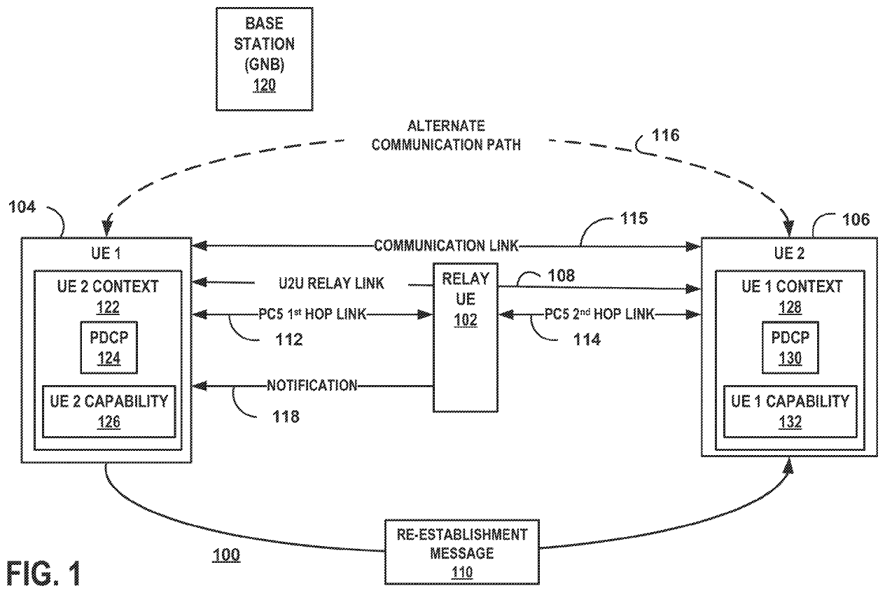

FIG. 1 is a block diagram of an example of a system 100 where a relay user equipment (UE) device 102 is facilitating data communication between a first UE device 104 and a second UE device 106 over a U2U relay communication link 108 and the first UE device 104 sends a reestablishment message 110. The U2U relay link 108 includes a first hop PC5 link 112 and a second hop PC5 link 114. The U2U relay communication link 108 is a sidelink communication link 115 that enables data transmission between the two devices 104, 106. The first UE device 104 determines that an alternate communication path 116 should be established because the current sidelink communication link 115 (U2U relay link 108) has a quality below a threshold, experienced a radio link failure (RLF), or otherwise exhibits characteristics that fall below an acceptable quality threshold to continue communication over the U2U relay link 108. In some situations, the determination may be based on a notification 118 received from the relay UE device 102. Examples of information that may be conveyed by the notification 118 include a detected RLF of the second hop PC5 link 114, a signal quality of the second hop PC5 link 114, and an indicator that the signal quality of the second hop PC5 link 114 has fallen below a threshold. Information regarding the signal quality may include, or may be based on, a SL RSRP level of the second hop PC5 link 114. The notification 118 may also be based on information received at the relay UE device 102 from the second UE device 104. In some situations, the notification 118 may be based on a lack of information received at the relay UE device. For example, the notification may be an RLF notification that is based on a discontinuous transmission (DTX) process where no feedback (e.g., HARQ feedback) is received from the second UE device 106 in response to data transmitted by the relay UE device 102. In another example where HARQ feedback is deployed, the relay UE device 102 may declare an RLF of the second hop PC5 link 114 after receiving a threshold exceeding number of HARQ NACK messages from the second UE device 106 in response to retransmissions of data from the relay UE device 102 to the second UE device 106. The notification 118 may be based on such an RLF determination.

In other situations where relay HARQ feedback is employed, the first UE device 104 may make the determination that the alternate communication path is needed based on a number of NACK responses from the second UE device 106 to retransmissions of data by the first UE device 104 or based on DTX where the first UE device 104 is not receiving expected HARQ feedback for transmissions.

In another example, the notification is an application-level message indicating that the requirements of the communication for the application exceed the capabilities of the current sidelink communication link. Such a notification may be triggered by a change in requirements or by a change in capabilities. Where the application requires additional bandwidth that cannot be supported by the communication link, for example, one UE device may send the notification to the peer UE device.

In response to the reestablishment message 110, the alternate communication path 116 is established where information regarding the communication between the two UE devices 104, 106 is retained at the UE device 104, 106 and applied to the alternate communication path 116. As discussed below, such retained information may include the context of the peer UE device. For the examples, at least the Packet Data Convergence Protocol (PDCP) configuration of communication link 115 is used for the reestablished communication link. In some examples, the alternate communication path 116 is a PC5 direct link to between the two UE devices 104, 106. In other examples, the alternate communication path 116 is an alternate U2U relay link. As described below, the reestablishment message 110 initiates the exchange of one or more messages between the UE devices 104, 106 in some examples.

The relay UE device 102 may also take action when the first UE device 104 determines an alternate communication path is needed. In one example, the relay UE device 102 may detect an RLF on the first hop PC5 link 112 at the same time (or nearly the same time) as the first UE device 104 determines the alternate communication path is required. The relay UE device 102 informs the second UE device 106 of the RLF. The relay UE device 102 may also inform the second UE device 106 that the relay device will release the second hop PC5 link 114 with an indication that the reason for the release is the RLF of the first hop PC5 link 112.

The system 100 also includes a base station (gNB) 120 for the example. In many situations, the base station 120 is not directly involved in the communication link reestablishment. The base station 120, however, may facilitate configuration parameters of the UE devices 102, 104, 106 or provide other system operational parameters. In some situations, for example, the base station 120 may allocate and manage communication resources where one or more of the UE devices 102, 104, 106 are in coverage (InC) of the base station 120.

As discussed below, the UE context for each peer device for the sidelink communication link 115 is retained and applied to the alternate communication path 116 to reestablish the sidelink communication link 115. A second UE device UE context 122 is maintained at the first UE device 104 where the context 122 includes at least the PDCP 124 for the sidelink communication link 115 and the second device UE capability 126. A first UE device UE context 128 is maintained at the second UE device 106 where the context 128 includes at least the PDCP 130 for the sidelink communication link 115 and the first device UE capability 132.

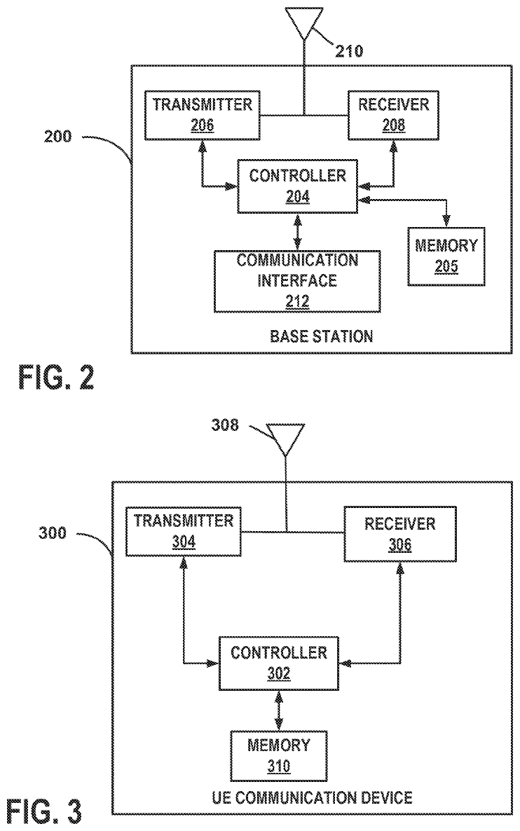

FIG. 2 is a block diagram of an example of a base station (gNB) 200 suitable for use as the base station (gNB) 120. The base station 200 includes a controller 204, transmitter 206, and receiver 208, as well as other electronics, hardware, and code. The base station 200 is any fixed, mobile, or portable equipment that performs the functions described herein. The various functions and operations of the blocks described with reference to the base station 106 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory 205. The transmitter 206 includes electronics configured to transmit wireless signals.

In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. The antenna 210 may also include multiple transmit and receive antennas.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the base station functions. The required components may depend on the particular functionality required by the base station.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

FIG. 3 is a block diagram of an example of a UE device 300 suitable for use as each of the UE devices 102, 104, 106, 400. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory 310. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device. At least the transmitter 304 and receiver 306 form a transceiver in the example. The controller 308 and memory 310 may also be part of the transceiver.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

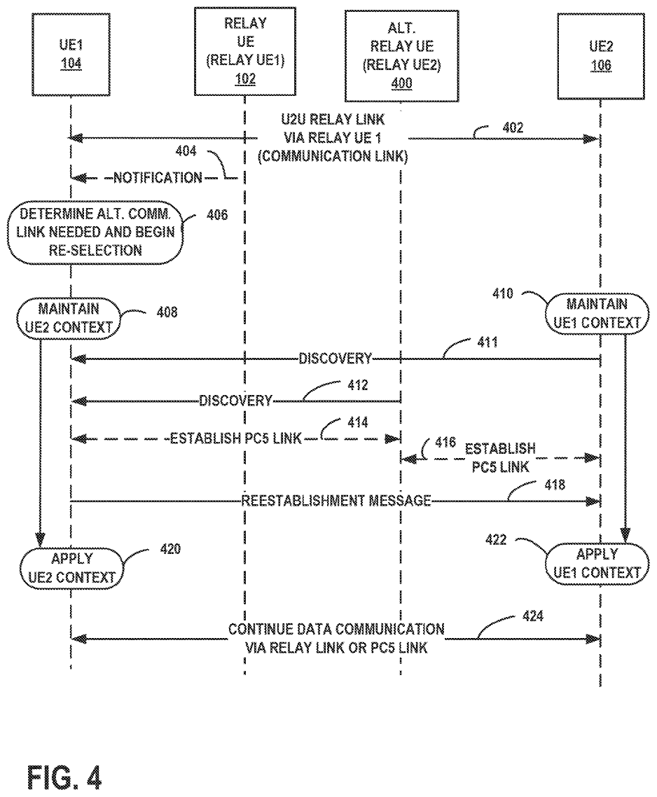

FIG. 4 is a message diagram of an example of reestablishment of a sidelink communication link between the first UE device 104 and the second UE device 106. The message exchange and events discussed with reference to FIG. 4, therefore, are an example of the technique discussed with reference to FIG. 1. For the example, an alternate relay link is established through an alternate relay UE device 400 to switch from the U2U relay link through the relay UE device 102 to a U2U relay link through the alternate relay UE device 400.

At event 402, data is exchanged in a communication session between the first UE device and the second UE device. The example of FIG. 4 begins with the first device UE device 104 communicating with the second UE device over a U2U relay link 108 facilitated by the relay UE device 102.

A transmission 404, a notification 118 is sent by the relay UE device 102 to the first UE device 104. The notification 118 is any transmission, control signal, or message that provides the first UE device 104 with information pertaining to the quality of the U2U relay link 108. In some circumstances, the notification 118 includes an indication that a radio link failure (RLF) has occurred on the second hop PC5 link 114. In other situations, the notification 118 provides information regarding the quality of the second hop PC5 link 114. Although the link quality may be based on various parameters and/or measurements, an example of a suitable measurement includes a Sidelink Reference Signal Received Power (SL RSRP) measurement of the second hop PC5 link 114. The SL RSRP may be measured by the relay UE device 102 and the notification 118 may be an indicator indicating that the SL RSRP is below a threshold. The notification 118 may also be a parameter, value, or other indication indicative of the measured SL RSRP value. In another example, the notification 118 is an indicator based on HARQ feedback from the second UE device 106. The notification 118 may indicate the relay UE device 102 has detected a DTX for one or more transmissions to the second UE device 106. The notification 118 may also indicate that a maximum number of NACK messages have been received from the second UE device 106 for retransmissions by the relay UE device 102 to the second UE device 106. The notification 118, therefore, provides the first UE device 104 with information that can be used to determine whether to reestablish the communication link to the second UE device 106. The arrow with reference number 404 in FIG. 4 is illustrated with a dashed line to indicate that the notification 118 may not be sent by the relay UE device 102 and/or may not be received by the first UE device 104 in some circumstances.

At event 406, the first UE device 104 determines an alternate communication path should be established to reestablish the sidelink communication link and begins a reselection process. The determination may be based on information captured, measured, tracked, or otherwise determined only by the first UE device, based on only information provided by the notification 118, or based on any combination of received information in the notification 118 and information determined by the first UE device 104. Examples of information determined by the first UE device 104 include detection of RLF of the first hop PC5 link 412, HARQ feedback associated with the first hop PC5 link 412, end-to-end HARQ feedback from the second UE device associated with the U2U relay link 108, and signal quality measurements of the first hop PC5 link 412, such as SL RSRP. The HARQ feedback information includes detection of DTX in some circumstances.

After determining that the alternate communication path should be reestablished, the first UE device 104 begins a reselection process. In accordance with known techniques, the first UE device 104 may evaluate reference signals from nearby UE devices, neighbor lists, and other information to select a suitable candidate relay UE device to establish an alternate U2U relay link or determine that a direct PC5 link can be established to the second UE device 106. For the example, the first UE device 104 receives and evaluates discovery signals from UE devices as discussed below.

At event 408, the first UE device 104 maintains the context of the second UE device 408. Accordingly, the first UE device 104 does not discard information associated with the second UE device 106 after determining that the quality of the current U2U relay link 108 has fallen below an acceptable threshold. Similarly, the second UE device 410 maintains the context of the first UE device 104 and event 410. The retention of the first UE device context at the second UE device 106 may be a result of normal operation where the second UE device 106 is unaware that the communication link between the UE devices 104, 106 needs to be reestablished. In some situations, the second UE device 106 may also be aware that the communication link needs to be reestablished and maintains the context. For the example, the context that each UE device maintains includes at least the UE capability and the Packet Data Convergence Protocol (PDCP) configuration for the peer UE device.

At transmissions 411 and 412, the discovery signals are received at the first UE device 104. For the example of FIG. 4, the second UE device transmits a discovery signal at transmission 411 and an alternate relay UE device (second relay UE device) 400 transmits a discovery signal at transmission 412. The fist UE device 104 may receive numerous discovery signals from nearby UE devices in evaluating the candidates and selecting a UE device for communication to the second UE device 106. Accordingly, the first UE device 104 may receive discovery signals from other potential relay UE devices in some circumstances.

At event 414, a PC5 link is established between the first UE device and the alternate relay UE device 400. At event 416, a PC5 link is established between the alternate relay UE device 400 and the second UE device 106. The events 414, 416 are shown as dashed lines in FIG. 4 since it is possible that the events 414, 416 may be a component of the transmission 418 of a reestablishment message 110 or a PC5 connection is established between the first UE device 104 and the second UE device 106 and an alternate relay UE device is not needed. In some situations, the PC5-S unicast connection is maintained and the PC5 links do not need to be established at events 414, 416.

At transmission 418, a reestablishment message 110 is transmitted by the first UE device 104 to the second UE device 106. The reestablishment message 110 may be sent directly through a PC5 link or through the alternate relay UE device 400 depending on the results of the reselection procedure. The reestablishment message 110 invokes the reestablishment of a communication link between the first UE device 104 and the second UE device 106 which may include response messages.

At event 420, the first UE device 104 applies the second UE device context to the reestablished communication link between the first UE device and the second UE device 106. At event 422, the second UE device 106 applies the first UE device context to the reestablished communication link between the first UE device and the second UE device 106. After the contexts are applied, data communication between the first UE device and the second UE device 106 continues at event 424 over the reestablished communication link where the link may be a direct PC5 link or a U2U relay link facilitated by the alternate relay UE device 400.

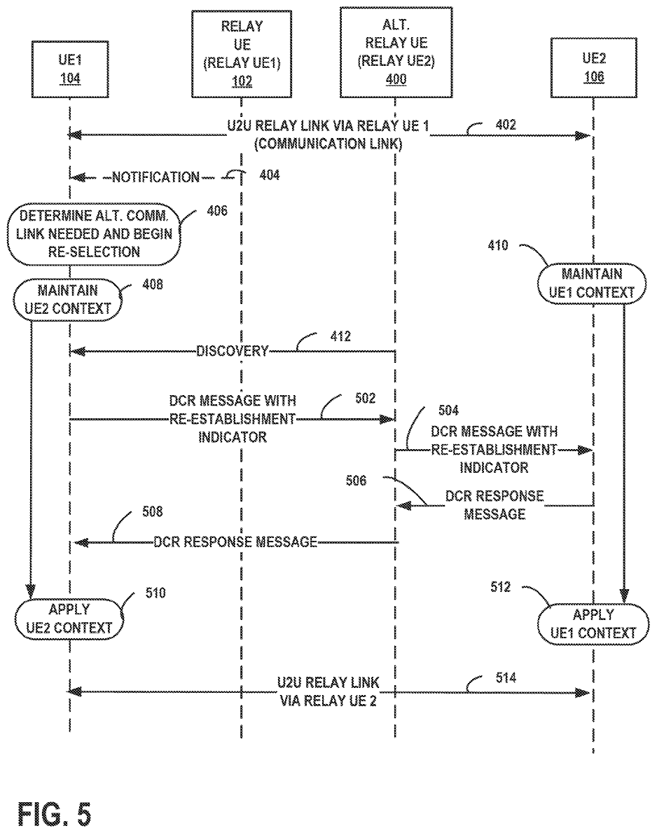

FIG. 5 is a message diagram of an example of reestablishment of a communication link between the first UE device 104 and the second UE device 106 through an alternate relay UE device 400 where the reestablishment message 110 includes a direct communication request (DCR) message with a reestablishment indicator. The message exchange and events discussed with reference to FIG. 5, therefore, are an example of the techniques discussed with reference to FIG. 1 and FIG. 4. Events 402, 404, 406, 408, 410, 412 are performed in accordance with the discussion with reference to FIG. 4. Transmission 411 is omitted in the interest of brevity and clarity since a U2U relay link is reestablished via the alternate relay UE device 400 for the example of FIG. 5.

At transmission 502, a DCR message with a reestablishment indicator is transmitted by the first UE device 104 to the alternate relay UE device 400. For the example, the DCR message is generated and transmitted similarly to conventional DCR messages but includes the reestablishment indicator. The reestablishment indicator indicates that the DCR message is not to establish a new direct connection but is instead to reestablish a current communication session. An example of a suitable technique for including a reestablishment indicator in the DCR message includes transmitting a ProSe direct link establishment request message that includes an IE indicating the DCR message is for reestablishment. The DCR message includes a first UE device identifier identifying the first UE device 104 a second UE device identifier identifying the second UE device 106.

At transmission 504, the alternate relay UE device 400 transmits a DCR message with a reestablishment indicator to the second UE device that indicates the first UE device 104 is making a direct communication request to the second UE device 106 to reestablish a communication link. The DCR message with a reestablishment indicator is similar to a DCR message transmitted by relay UE device in conventional techniques except that the reestablishment indictor is included.

At transmission 506, the second UE device 106 sends a DCR response message to the relay UE device 102.

At transmission 508, the relay UE device 102 sends a DCR response message to the first UE device 104. In some situations, each Direct Request Communication Response message in transmission 506 and transmission 508 indicates that the DCR is accepted but reestablishment is not accepted. Therefore, the second UE device may inform the first UE device in the response that reestablishment is accepted or may inform the first UE device that DCR is accepted but without accepting the reestablishment. For example, if the second UE device has already cleared the first UE context, the second UE device will not accept reestablishment but can accept the DCR for new communication.

At event 510, the first UE device 104 applies the second UE device context to the reestablished communication link between the first UE device and the second UE device 106. At event 512, the second UE device 106 applies the first UE device context to the reestablished communication link between the first UE device and the second UE device 106. After the contexts are applied, data communication between the first UE device and the second UE device 106 continues at event 514 over the reestablished U2U relay link facilitated by the alternate relay UE device 400.

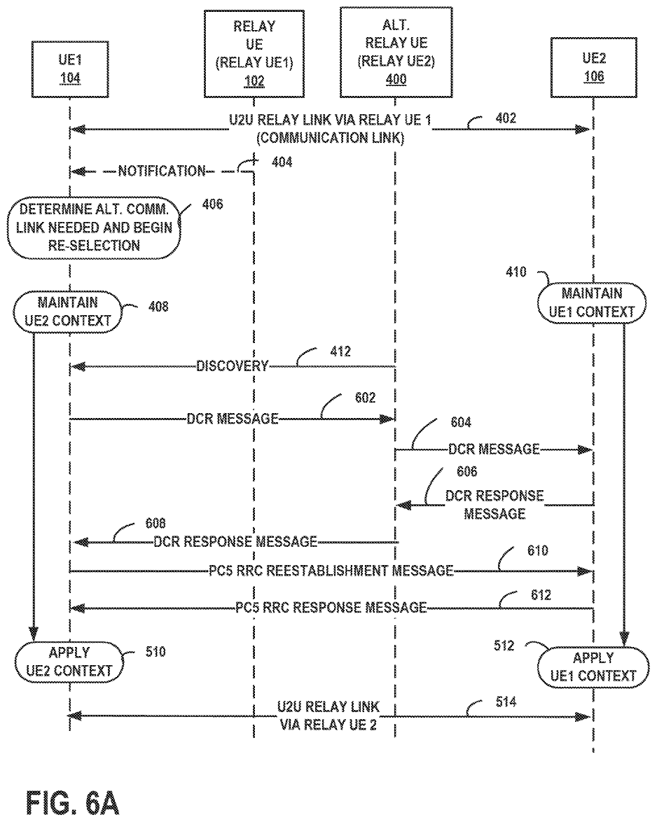

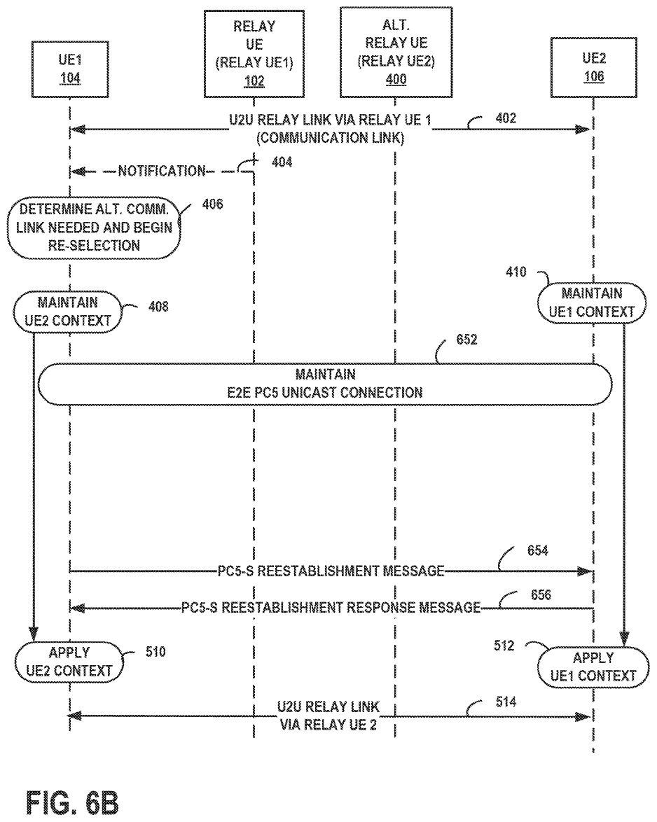

FIG. 6A is a message diagram of an example of reestablishment of a communication link between the first UE device 104 and the second UE device 106 through an alternate relay UE device 400 where the reestablishment message 110 includes a PC5-RRC reestablishment message. The message exchange and events discussed with reference to FIG. 6A, therefore, are an example of the techniques discussed with reference to FIG. 1 and FIG. 4. Events 402, 404, 406, 408, 410, 412 are performed in accordance with the discussion with reference to FIG. 4. Transmission 411 is omitted in the interest of brevity and clarity since a U2U relay link is reestablished via the alternate relay UE device 400 for the example of FIG. 6A. For the example of FIG. 6A, as part of event 408 and event 410, the end-to-end (E2E) PC5-RRC connection is maintained by each UE device 104, 106 by not releasing the connection. Therefore, although the physical communication link between the two devices may be compromised, the UE devices 104, 106 maintain the PDCP information and any other information necessary to facilitate transmission of RRC messages once the communication link is reestablished. For the example of FIG. 6A, however, the E2E PC5-S unicast connection is released.

At transmission 602, a DCR message is transmitted by the first UE device 104 to the alternate relay UE device 400. For the example, the DCR message is generated and transmitted in accordance to conventional DCR messages. The DCR message includes a first UE device identifier identifying the first UE device 104 a second UE device identifier identifying the second UE device 106.

At transmission 604, the alternate relay UE device 400 transmits a DCR message to the second UE device that indicates the first UE device 104 is making a direct communication request to the second UE device 106.

At transmission 606, the second UE device 106 sends a DCR response message to the relay UE device 102.

At transmission 608, the relay UE device 102 sends a DCR response message to the first UE device 104. Accordingly, transmissions 602 and 604 are example of establishing a PC5 link and subsequently the corresponding PC5-RRC connection between the first UE device 104 and the alternate relay UE device 400 and transmissions 606 and 608 are example of establishing a PC5 link and subsequently the corresponding PC5-RRC connection between the second UE device 106 and the alternate relay UE device 400.

At transmission 610, the first UE device 104 sends an E2E PC5-RRC reestablishment message to the second UE device 106 via the alternate relay UE device 400. The PC5-RRC reestablishment message indicates to the second UE device that the previous communication link is being reestablished. Although the PC5-RRC reestablishment message may include any of several formats and/or configurations, an example of a suitable PC5-RRC reestablishment message includes an SL Reconfiguration message with a reestablishment indicator. In one example, the reestablishment indicator in the SL Reconfiguration message is an information element (IE) for indicating that the SL Reconfiguration is a reestablishment of the previous communication link between the two UE devices 104, 106.

At transmission 612, the second UE device sends a PC5-RRC response message to the first UE device 104 to confirm the reestablishment of the communication link. An example of suitable PC5-RRC response message includes an RRCReconfigurationComplete Sidelink message. In some situations, the second UE device may reject the reestablishment request and may send a message indicating the rejection. In other situations, the second UE device may reject the reestablishment request but accepts the PC5-RRC reestablishment message as an RRC establishment request for new communication. Accordingly, the PC5-RRC response message may indicate acceptance of the reestablishment, nonacceptance of the reestablishment and acceptance of new communication establishment, or non-acceptance of any communication.

Events 510, 512 and 514 are performed as described above to continue the data transmission over the U2U relay link facilitated by the alternate relay UE device 400.

FIG. 6B is a message diagram of an example of reestablishment of a communication link between the first UE device 104 and the second UE device 106 through an alternate relay UE device 400 where the reestablishment message 110 includes a PC5-S reestablishment message. The message exchange and events discussed with reference to FIG. 6B, therefore, are an example of the techniques discussed with reference to FIG. 1 and FIG. 4. Events 402, 404, 406, 408, 410, 412 are performed in accordance with the discussion with reference to FIG. 4. Transmission 411 is omitted in the interest of brevity and clarity since a U2U relay link is reestablished via the alternate relay UE device 400 for the example of FIG. 6B. For the example of FIG. 6A, as part of event 408 and event 410, the end-to-end (E2E) PC5-RRC connection is maintained by each UE device 104, 106 by not releasing the connection. In addition, the E2E PC5-S unicast connection is maintained and not released for the example of FIG. 6B. From the perspective of the higher layers, the connection is maintained between the UE devices. Therefore, although the physical communication link between the two devices may be compromised, the UE devices 104, 106 maintain the PDCP information, information related to E2E PC5 unicast connection, and any other information necessary to facilitate transmission of PC5-S messages once the communication link is reestablished At event 652, the E2E PC5-S unicast connection is maintained. The higher communication layers at both UE devices do not discard information regarding the E2E PC5-S unicast connection.

At transmission 654, the first UE device 104 sends a PC5-S reestablishment message to the second UE device 106 via the alternate relay UE device 400. The PC5-S reestablishment message indicates to the second UE device that the previous communication link is being reestablished. Although the PC5-S reestablishment message may include any of several formats and/or configurations, an example of a suitable PC5 reestablishment message includes a PC5-S message with a reestablishment indicator indicating it is reestablishment message and including the L2ID of the first UE device.

At transmission 656, the second UE device sends a PC5-S response message to the first UE device 104 to confirm the reestablishment of the communication link. An example of suitable PC5-S response message includes a PC5-S message indicating it is a response to the PC5-S reestablishment message. In some situations, the second UE device may reject the reestablishment request and may send a message indicating the rejection. In one example, the PC5-S response message indicating a rejection includes a cause value that is indicative of the reason for the rejection. For example, the cause value may indicate the first UE context has been discarded or the SL-RSRP has fallen below a minimum threshold. The first UE device takes appropriate action depending on the cause value. If the cause value indicates that the UE context has been discarded, the first UE device sends a RRCReconfiguration Sidelink to the second UE device to configure PDCP and to share its UE capability. In some situations, the second UE device sends a RRCReconfiguration Sidelink. If the cause is due to a radio link problem at the second UE device, the first UE device may simply release the E2E unicast connection using a PC5-S release message and initiate a relay reselection procedure. In some situations, the second UE device releases the E2E unicast connection using a PC5-S release message.

Events 510, 512 and 514 are performed as described above to continue the data transmission over the U2U relay link facilitated by the alternate relay UE device 400.

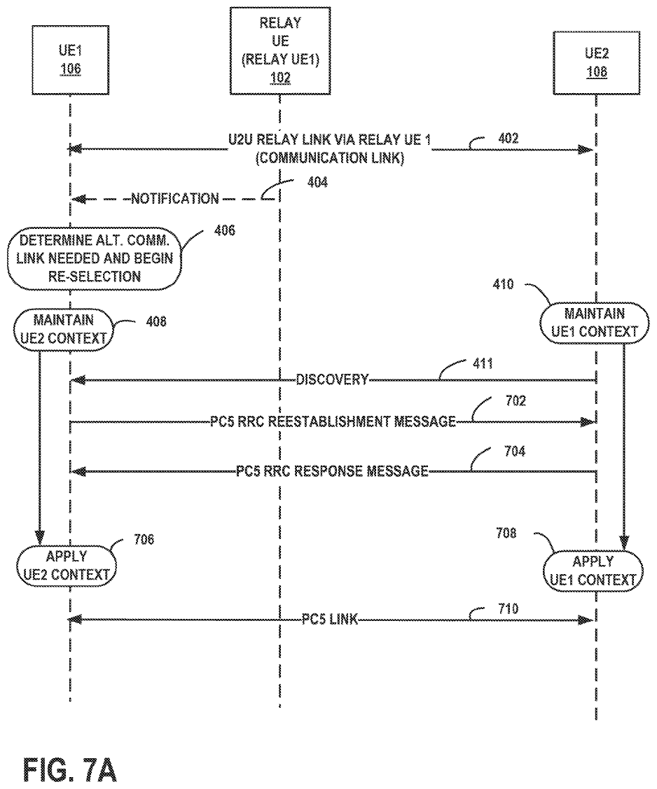

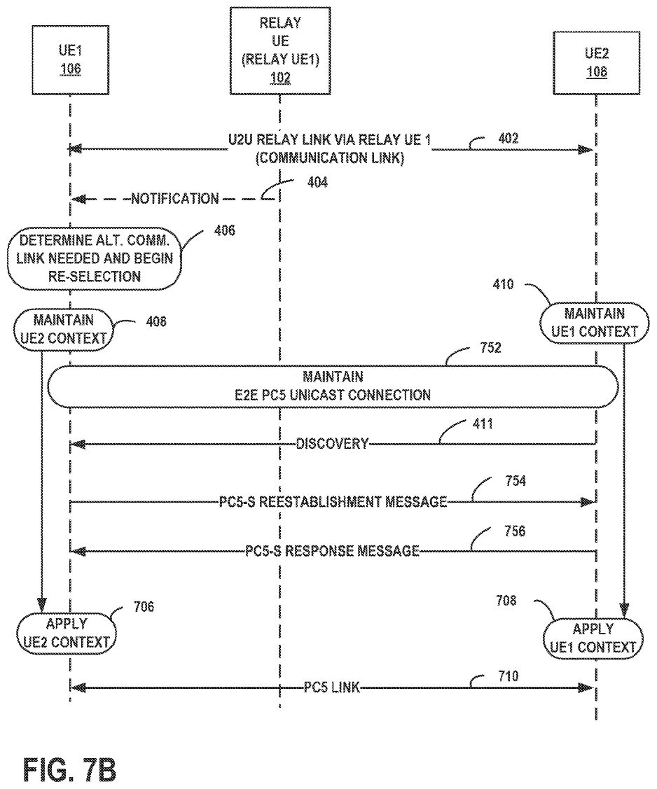

FIG. 7A is a message diagram of an example of reestablishment of a communication link between the first UE device 104 and the second UE device 106 through a direct PC5 link where an PC5-RRC reestablishment message is transmitted. The message exchange and events discussed with reference to FIG. 7A, therefore, are an example of the techniques discussed with reference to FIG. 1 and FIG. 4. Events 402, 404, 406, 408, 410, 411 are performed in accordance with the discussion with reference to FIG. 4. Transmission 412 is omitted in the interest of brevity and clarity since a direct PC5 link is established without an alternate relay UE device 400 for the example of FIG. 7A. For the example of FIG. 7A, as part of event 408 and event 410 the E2E PC5-RRC connection is maintained by each UE device 104, 106 by not releasing the connection. Therefore, although the physical communication link between the two devices 104, 106 may be compromised, the UE devices 104, 106 maintain the PDCP information and any other information necessary to facilitate transmission of RRC messages once the communication link is reestablished.

At transmission 702, the first UE device 104 sends a PC5-RRC reestablishment message directly to the second UE device 106 over a PC5 link. For the example of FIG. 7A, the PC5-S unicast connection is maintained. In some situations, the PC5-S unicast connection is not maintained. In such situations, it may be possible for the first UE device to send a DCR message and the second UE device to send a DCR response to establish the PC5-S unicast connection before the PC5-RRC reestablishment is transmitted. Where the PC5 radio link is such that the measured SL-RSRP falls below a threshold or if the max number of DTX has been reached and a SL-RLF is declared, the UE context may still be kept, the PC5 link is considered to be still connected and the PC5-S Reestablishment message is transmitted. In other situations, however, the first UE device or the second UE device has released the PC5-S connection (using a PC5-S message), the UE context is not maintained and the PC5-S reestablishment message cannot be used to reestablish the sidelink communication link. The PC5-RRC reestablishment message indicates to the second UE device 106 that the previous communication link is being reestablished. Although the PC5-RRC reestablishment message may include any of several formats and configuration, an example of a suitable message includes a RRCReconfigurationSidelink message with a reestablishment indicator. In one example, the reestablishment indicator in the RRCReconfigurationSidelink message is an information element (IE) for indicating that the RRC Sidelink Reconfiguration is a reestablishment of the previous communication link between the two UE devices 104, 106.

At transmission 704, the second UE device sends a PC5-RRC response message to the first UE device 104 to confirm the reestablishment of the communication link. An example of suitable PC5-RRC response message includes an RRCReconfigurationComplete Sidelink message.

At event 706, the first UE device 104 applies the second UE device context including the PDCP information to the reestablished communication link between the first UE device and the second UE device 106. At event 708, the second UE device 106 applies the first UE device context including the PDCP information to the reestablished communication link between the first UE device and the second UE device 106.

Accordingly, the E2E PC5-RRC connection is maintained. After the contexts and information are applied, data communication between the first UE device 104 and the second UE device 106 continues at event 710 over the reestablished communication link using PC5 direct communication.

FIG. 7B is a message diagram of an example of reestablishment of a communication link between the first UE device 104 and the second UE device 106 through a direct PC5 link where an PC5-S reestablishment message is transmitted. The message exchange and events discussed with reference to FIG. 7B, therefore, are an example of the techniques discussed with reference to FIG. 1 and FIG. 4. Events 402, 404, 406, 408, 410, 411 are performed in accordance with the discussion with reference to FIG. 4. Transmission 412 is omitted in the interest of brevity and clarity since a direct PC5 link is established without an alternate relay UE device 400 for the example of FIG. 7B. For the example of FIG. 7B, as part of event 408 and event 410 the E2E PC5-RRC connection is maintained by each UE device 104, 106 by not releasing the connection. In addition, the E2E PC5-S unicast connection is maintained and not released for the example of FIG. 7B. From the perspective of the higher layers, the connection is maintained between the UE devices. Therefore, although the physical communication link between the two devices may be compromised, the UE devices 104, 106 maintain the PDCP information, information related to E2E PC5-S unicast connection, and any other information necessary to facilitate transmission of PC5-S messages once the communication link is reestablished At event 752, the E2E PC5-S unicast connection is maintained. The higher communication layers at both UE devices do not discard information regarding the E2E PC5-S unicast connection.

At transmission 754, the first UE device 104 sends a PC5-S reestablishment message directly to the second UE device 106 over a PC5 link. The PC5-S reestablishment message indicates to the second UE device 106 that the previous communication link is being reestablished. Although the PC5-S reestablishment message may include any of several formats and/or configurations, an example of a suitable PC5 reestablishment message includes a PC5-S message with a reestablishment indicator indicating it is reestablishment message and including the L2ID of the first UE device.

At transmission 756, the second UE device sends a PC5-S response message to the first UE device 104 to confirm the reestablishment of the communication link. An example of suitable PC5-S response message includes a PC5-S message indicating it is a response to the PC5-S reestablishment message. In some situations, the second UE device may reject the reestablishment request and may send a message indicating the rejection. In one example, the PC5-S response message indicating a rejection includes a cause value that is indicative of the reason for the rejection. For example, the cause value may indicate the first UE context has been discarded or the SL-RSRP has fallen below a minimum threshold. The first UE device, takes appropriate action depending on the cause value. If the cause value indicates that the UE context has been discarded, the first UE device sends a RRCReconfiguration Sidelink to the second UE device to configure PDCP and to share its UE capability. In some situations, the second UE device sends a RRCReconfiguration Sidelink. If the cause is due to a radio link problem at the second UE device, the first UE device may simply release the E2E unicast connection using a PC5-S release message and initiate a relay reselection procedure. In some situations, the second UE device releases the E2E unicast connection using a PC5-S release message.

At event 706, the first UE device 104 applies the second UE device context including the PDCP information to the reestablished communication link between the first UE device and the second UE device 106. At event 708, the second UE device 106 applies the first UE device context including the PDCP information to the reestablished communication link between the first UE device and the second UE device 106. Accordingly, the E2E PC5-RRC connection and the PC5-S unicast connection are maintained. After the contexts and information are applied, data communication between the first UE device 104 and the second UE device 106 continues at event 710 over the reestablished communication link using PC5 direct communication.

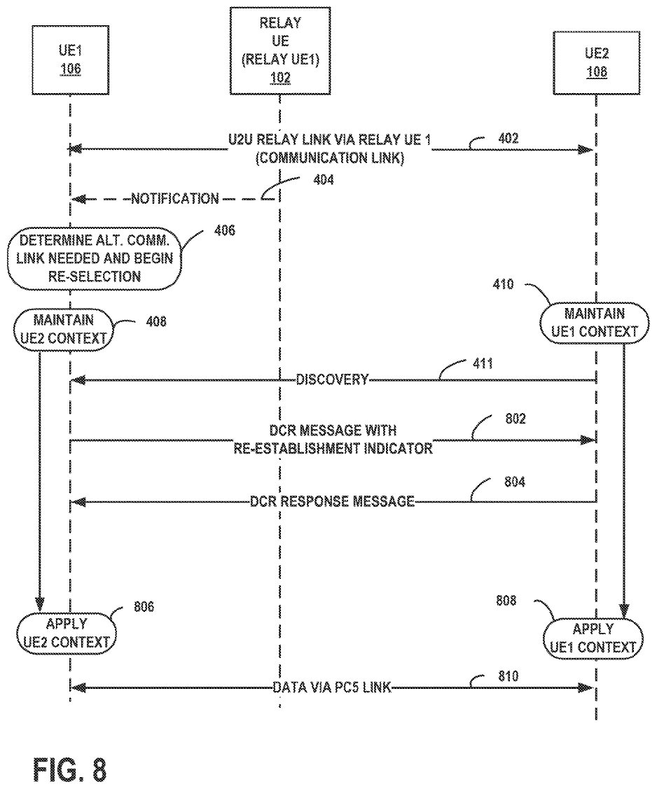

FIG. 8 is a message diagram of an example of reestablishment of a communication link between the first UE device and the second UE device through a direct PC5 link where the reestablishment message 110 includes a direct communication request (DCR) message with a reestablishment indicator. The message exchange and events discussed with reference to FIG. 8, therefore, are an example of the techniques discussed with reference to FIG. 1 and FIG. 4. Events 402, 404, 406, 408, 410, 411 are performed in accordance with the discussion with reference to FIG. 4. Transmission 412 is omitted in the interest of brevity and clarity since no U2U relay link is reestablished via the alternate relay UE device 400 for the example of FIG. 8.

At transmission 802, a DCR message with a reestablishment indicator is transmitted by the first UE device 104 to the alternate relay UE device 400. For the example, the DCR message is generated and transmitted similarly to conventional DCR messages but includes the reestablishment indicator. The reestablishment indicator indicates that the DCR message is not to establish a new direct connection but is instead to reestablish a current communication session. An example of a suitable technique for including a reestablishment indicator in the DCR message includes transmitting a ProSe direct link establishment request message that includes an IE indicating the DCR message is for reestablishment. The DCR message includes a first UE device identifier identifying the first UE device 104 a second UE device identifier identifying the second UE device 106. For the example of FIG. 8, the E2E PC5-S unicast connection is assumed to be released

At transmission 802, the alternate relay UE device 400 transmits a DCR message with a reestablishment indicator to the second UE device that indicates the first UE device 104 is making a direct communication request to the second UE device 106 to reestablish a communication link. The DCR message with a reestablishment indicator is similar to a DCR message transmitted by relay UE device in conventional techniques except that the reestablishment indictor is included. An example of a suitable technique for including a reestablishment indicator in the DCR message includes transmitting a ProSe direct link establishment request message that includes an IE indicating the DCR message is for reestablishment. The DCR message includes a first UE device identifier identifying the first UE device 104 a second UE device identifier identifying the second UE device 106.

At transmission 804, the second UE device 106 sends a DCR response message to the first UE device 104. In some situations, the Direct Request Communication Response message indicates that the DCR is accepted but reestablishment is not accepted. Therefore, the second UE device may inform the first UE device in the response that reestablishment is accepted or may inform the first UE device that DCR is accepted but without accepting the reestablishment. For example, if the second UE device has already cleared the first UE context, the second UE device will not accept reestablishment but can accept the DCR for new communication.

At event 806, the first UE device 104 applies the second UE device context to the reestablished communication link between the first UE device and the second UE device 106. At event 808, the second UE device 106 applies the first UE device context to the reestablished communication link between the first UE device and the second UE device 106. After the contexts are applied, data communication between the first UE device and the second UE device 106 continues at event 810 over the reestablished U2U relay link over a direct PC5 link.

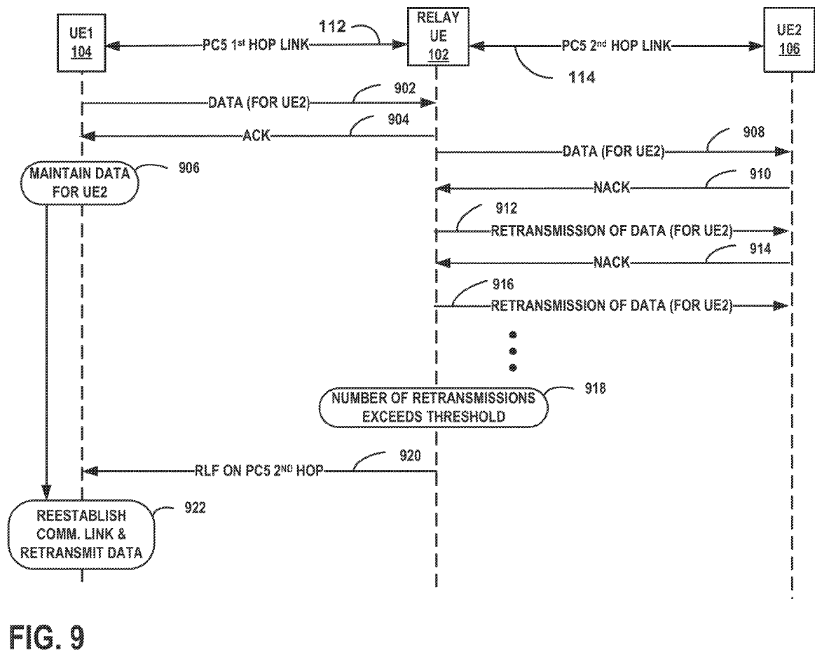

FIG. 9 is a message diagram of an example of relay HARQ feedback where the relay UE device 102 provides feedback for the first hop PC5 link 112 and performs retransmissions over the second PC5 link 114 in response to NACK feedback from the second UE device 106. For the example, therefore, the first UE device 104 is communicating with the second UE device 106 over a relay link via the relay UE device 102.

At transmission 902, the first UE device 104 transmits data to the relay UE device 102 where the second UE device is the intended recipient of the data. The data, therefore, is for the second UE device 106.

At transmission 904, HARQ feedback regarding the transmission 902 is provided to the first UE device 104 by the relay UE device 102. For the example, the HARQ feedback is an ACK indicating that the transmission 902 was successfully received at the relay UE device 102.

At event 906, the first UE device 104 maintains or otherwise retains the data for the second UE device that was sent to the relay UE device 102 in the transmission 902. For the example, therefore, the first UE device 104 does not discard the data even when an ACK feedback message is received.

At transmission 908, the relay UE device 102 transmits the data to the second UE device 106. The data received in the transmission 902, therefore, is forwarded by the relay UE device 102 to the second UE device 106.

At transmission 910, the second UE device 106 transmits HARQ feedback to the relay UE device 102. For the example, the HARQ feedback is a NACK message indicating that the transmission 902 was not successfully received at the second UE device 106.

At transmission 912, the relay UE device 102 retransmits the data to the second UE device 106. For the example, the relay UE device 102 retransmits the data in a number of retransmissions 912, 916 in response to the NACK feedback messages 910, 914 received for the transmissions 908, 912, 916 with the data to the second UE device 106.

At event 918, the relay UE device 102 determines that the number of unsuccessful transmissions has exceeded a threshold number. Although the threshold number may be any number equal to or greater than one, an example of a suitable threshold number is four. After receiving the last NACK and in response to the threshold number of transmissions, the relay UE device 102 determines that an RLF has occurred on the second hop PC5 link 114.

At transmission 910, the relay UE device notifies the first UE device 104 that that an RLF has occurred on the second hop PC5 link 114. For the example, the RLF notification is provided via an SL RRC message.

At event 922, the first UE device 104 reestablishes the communication link with the second UE device and retransmits the data that was originally transmitted in transmission 902.

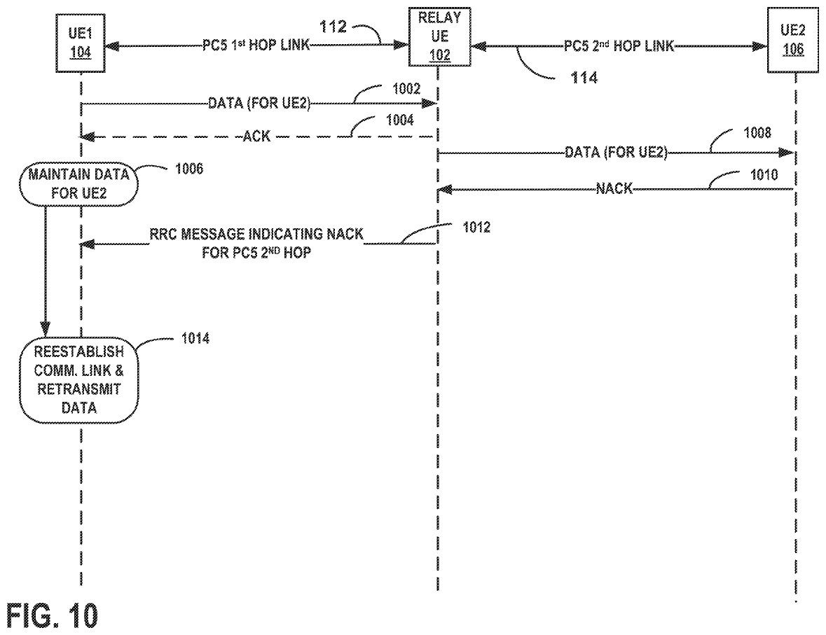

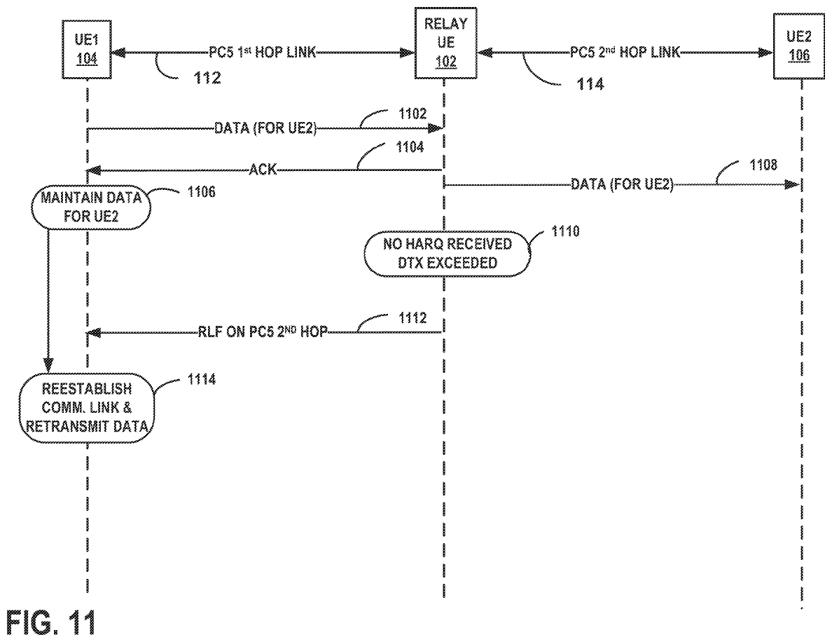

FIG. 10 is a message diagram of an example of relay HARQ feedback where the relay UE device 102 provides feedback for the transmission over the second hop PC5 link 112 via an RRC message in response to NACK feedback from the second UE device 106. For the example, the first UE device 104 is communicating with the second UE device 106 over a relay link via the relay UE device 102.

At transmission 1002, the first UE device 104 transmits data to the relay UE device 102 where the second UE device is the intended recipient of the data. The data, therefore, is for the second UE device 106.

At transmission 1004, HARQ feedback regarding the transmission 1002 is provided to the first UE device 104 by the relay UE device 102. For the example, the HARQ feedback is an ACK message indicating that the transmission 1002 was successfully received at the relay UE device 102. In some situations, the HARQ feedback for the first hop PC5 link 112 is omitted. Accordingly, the arrow in FIG. 10 representing the HARQ feedback transmission 1004 is shown with a dashed line to indicate the transmission 1004 can be omitted in some circumstances.

At event 1006, the first UE device 104 maintains or otherwise retains the data for the second UE device 106 that was sent to the relay UE device 102 in the transmission 902. For the example, therefore, the first UE device 104 does not discard the data even when an ACK feedback message is returned.

At transmission 1008, the relay UE device 102 transmits the data to the second UE device 106. The data received in the transmission 1002, therefore, is forwarded by the relay UE device 102 to the second UE device 106.

At transmission 1010, the second UE device transmits HARQ feedback to the relay UE device 102. For the example, the HARQ feedback is a NACK indicating that the transmission 1008 was not successfully received at the second UE device 106.

At transmission 1012, an RRC message with HARQ feedback is transmitted from the relay UE device 102 to the first UE device 104. The relay UE device 102 sends, to the first UE device 104, HARQ feedback for the transmission 1008 from the relay UE device 102 over the second hop PC5 link 114. For the example, the second hop PC5 link HARQ feedback is provided via an PC5-RRC message.

At event 1014, the first UE device 104 reestablishes the communication link with the second UE device and retransmits the data that was originally transmitted in transmission 1002. In some situations, the first UE device may retransmit the data and reestablish the communication link in response to receiving a maximum number of NACK messages.

FIG. 11 is a message diagram of an example of relay HARQ feedback where the relay UE device provides feedback for the first hop PC5 link 112 and declares a DTX in response to no HARQ feedback being received from the second UE device 106. The example begins with the first UE device 104 communicating with the second UE device 106 over a relay link via the relay UE device 102.

At transmission 1102, the first UE device 104 transmits data to the relay UE device 102 where the second UE device is the intended recipient of the data. The data, therefore, is for the second UE device 106.

At transmission 1104, HARQ feedback regarding the transmission 1102 is provided to the first UE device 104 by relay UE device 102. For the example, the HARQ feedback is an ACK indicating that the transmission 1102 was successfully received at the relay UE device 102.

At event 1106, the first UE device 104 maintains or otherwise retains the data for the second UE device that was sent to the relay UE device 102 in the transmission 1102. For the example, therefore, the first UE device 104 does not discard the data even when an ACK feedback message is returned.

At transmission 1108, the relay UE device 102 transmits the data to the second UE device 106. The data received in the transmission 1102, therefore, is forwarded by the relay UE device 102 to the second UE device 106.

At event 1110, the relay UE device 102 determines that a DTX condition has occurred. After a timer has expired from the time of the transmission 1102 without receiving HARQ feedback from the second UE device 106, the relay UE device 102 determines that a DTX condition has occurred indicating that an RLF on the second hop PC5 link 114 has occurred.

At transmission 1112, the relay UE device notifies the first UE device 104 that that an RLF has occurred on the second hop PC5 link 114. For the example, the RLF notification is provided via an PC5-RRC message.

At event 1114, the first UE device 104 reestablishes the communication link with the second UE device and retransmits the data that was originally transmitted in transmission 1102.

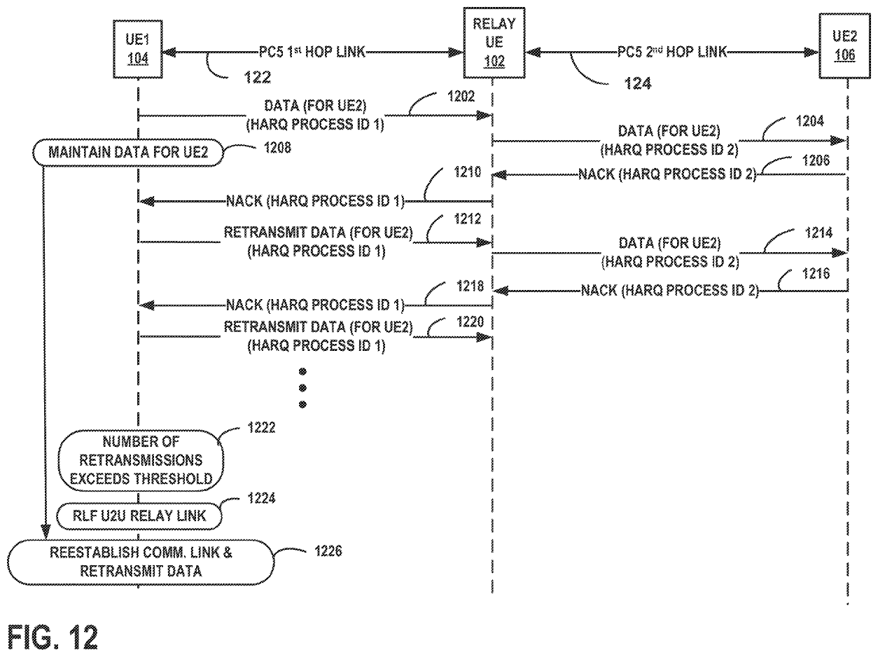

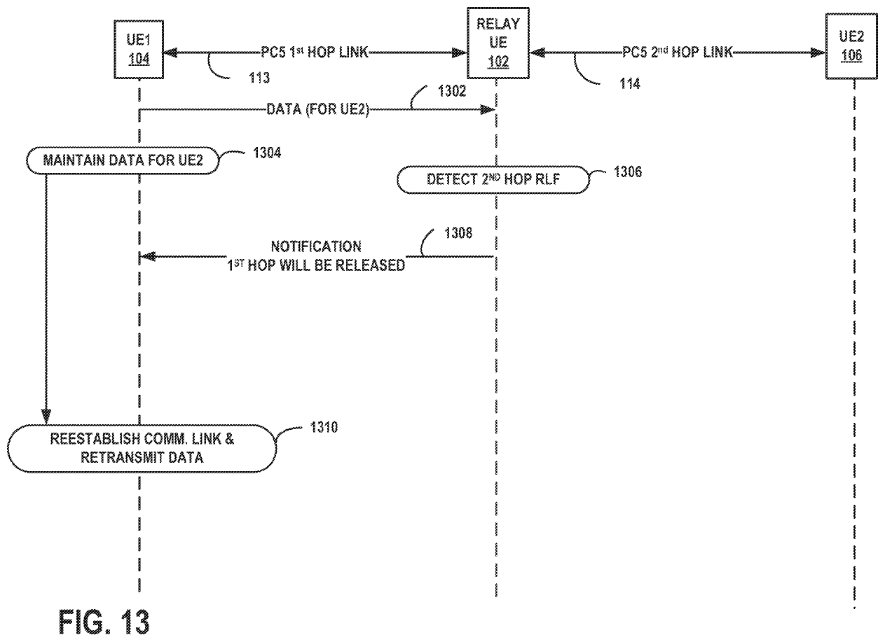

FIG. 12 is a message diagram of an example of relay HARQ feedback where the relay UE device 102 provides feedback using for the second hop PC5 link 114 using the HARQ process ID used for the transmission from the first UE device 104 to the relay UE device 102. For the example, therefore, the first UE device 104 is communicating with the second UE device 106 over a relay link via the relay UE device 102 where the relay UE device waits to receive HARQ feedback from the second UE device 106 before transmitting HARQ feedback to the first UE device 104.

At transmission 1202, the first UE device 104 transmits data to the relay UE device 102 where the second UE device is the intended recipient of the data. The data, therefore, is for the second UE device 106. The transmission 1202 includes a first HARQ process ID (ID1).

At transmission 1204, the relay UE device 102 transmits the data to the second UE device. The data received in the transmission 1202, therefore, is forwarded by the relay UE device 102 to the second UE device 106. The transmission 1204 includes a second HARQ process ID (ID2).

At transmission 1206, HARQ feedback regarding the transmission 1204 is provided to the relay UE device 102 by the second UE device 106. The transmission 1206 includes the second HARQ process ID (ID2). For the example, the HARQ feedback is a NACK message indicating that the transmission 1204 was not successfully received at the second UE device 106.

At event 1208, the first UE device 104 maintains or otherwise retains the data for the second UE device 106 that was sent to the relay UE device 102 in the transmission 1202. For the example of FIG. 12, the first UE device 104 does not discard the data unless an ACK message is received from the relay UE device.

At transmission 1210, HARQ feedback regarding the transmission 1204 is provided to the first UE device 104 by the relay UE device 102. Accordingly, the relay UE device 102 waits for the HARQ feedback from the second UE device 106 before sending feedback to the first UE device 104. If the data is successfully received at the second UE device 106, the relay UE device 102 provides an ACK. For the example, the HARQ feedback is a NACK message indicating that the transmission 1102 was not successfully received at the relay UE device 102. The transmission 1210 with the HARQ feedback for the second Hop PC5 link 114 uses the first HARQ process ID (ID1). For the example of FIG. 12, therefore, the HARQ feedback provides information regarding both hop PC5 links 112, 114. If either of the data transmissions over the first hop PC5 link 112 or the second hop PC5 link 114 is unsuccessful, the first UE device 104 will be notified with a NACK message. Although the first UE device 104 will not obtain any information regarding which PC5 link is bad, the first UE device 104 only monitors the physical sidelink feedback channel (PSFCH) for HARQ feedback. From the perspective of the first UE device 104, such relay HARQ feedback technique takes advantage of the conventional HARQ feedback techniques used for direct PC5 link communication between two UE devices using the PSFCH for feedback.

At transmission 1212, the first UE device 102 retransmits the data to the relay UE device 102. For the example, the first UE device 104 retransmits the data in a number of retransmissions 1212, 1220 in response to NACK feedback messages 1210, 1218 received for the transmissions 1202, 1212, 1220, with the data to the second UE device. For each retransmission, the relay UE device 102 retransmits the data to the second UE device 106 with a HARQ Process ID different than the HARQ process ID of the transmission from the first UE device 104. The same HARQ process ID used by the relay for the same data is used. The UE devices keep tabs of the revision number for each transmission, so that it knows how many times the same data was sent. Therefore, transmission 1212 uses the first HARQ process ID (ID1) and the retransmission 1214 from the relay UE device 102 includes the second HARQ process ID (ID2). The HARQ feedback NACK 1216 from the second UE device includes the second HARQ process ID (ID2) and the HARQ feedback NACK 1218 from the second UE device includes the first HARQ process ID (ID1). Each retransmission includes a revision number.

At event 1222, the first UE device 104 determines that the number of unsuccessful transmissions has exceeded a threshold number. Although the threshold number may be any number equal to or greater than one, an example of suitable threshold number is four. After receiving the last NACK message and in response to the threshold number of transmissions being reached, the first UE device 104 determines that an RLF has occurred somewhere along the relay communication link 108 connection to the second UE device 106 at event 1224.

At event 1226, the first UE device 104 reestablishes the communication link with the second UE device and retransmits the data that was originally transmitted in transmission 1202.

FIG. 13 is a message diagram of an example where the relay UE device 102 notifies the first UE device 104 that the first hop PC5 link 112 will be released. For the example, the first UE device 104 is communicating with the second UE device 106 over a relay link via the relay UE device 102.

At transmission 1302, the first UE device 104 transmits data to the relay UE device 102 where the second UE device is the intended recipient of the data. The data, therefore, is for the second UE device 106. The transmission 1202 includes a first HARQ process ID (ID1).

At event 1304, the first UE device 104 maintains or otherwise retains the data for the second UE device that was sent to the relay UE device 102 in the transmission 1302.

At event 1306, the relay UE device 102 determines an RLF has occurred on the second hop PC5 link 114. The determination may be based on a DTX condition, a maximum number of retransmissions, or other information.

At transmission 1308, the relay UE device 102 transmits a notification to the first UE device 104 indicating the first Hop PC5 link 112 will be released. For the example, the notification indicates that link is being released because an RLF has occurred on the second Hop PC5 link 114.

At event 1310, the first UE device 104 reestablishes the communication link with the second UE device and retransmits the data that was originally transmitted in transmission 1302.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A first user equipment (UE) device comprising:
a transceiver configured to communicate with a second UE device over a sidelink communication link through a relay UE device, the sidelink communication link having a Packet Data Convergence Protocol (PDCP) configuration; and
a controller configured to determine the sidelink communication link is no longer suitable for communication with the second UE device,
the transceiver comprising a transmitter configured to, in response to the determination by the controller that the sidelink communication link is no longer suitable for communication with the second UE device, transmit a sidelink reestablishment message to initiate a sidelink communication link reestablishment procedure to reestablish the sidelink communication link that maintains the PDCP configuration.

2. The first UE device of claim 1, wherein the transceiver comprises a receiver configured to receive a notification from the relay UE device, the controller configured to determine the sidelink communication link is no longer suitable for communication with the second UE device based at least partially on the notification.

3. The first UE device of claim 2, wherein the notification indicates a radio link failure has occurred.

4. The first UE device of claim 3, wherein the transmitter is configured to transmit a data transmission to the relay UE device, the data transmission comprising data for the second UE device, the notification comprising at least one HARQ feedback message.

5. The first UE device of claim 4, wherein the transmitter is configured to retransmit the data in retransmissions and the notification comprises a number of HARQ NACK messages sent in response to the data transmission and the retransmissions.

6. The first UE device of claim 2, wherein the notification is an application-layer message from the second UE device that is forwarded by the relay UE device.

7. The first UE device of claim 1, wherein the sidelink link reestablishment message is a PC5-S message comprising a reestablishment indicator.

8. The first UE device of claim 7, wherein the PC5-S message is a Direct Communication Request message to the destination UE device with the reestablishment indicator.

9. The first UE device of claim 1, wherein the relay link reestablishment message is a PC5-RRC reestablishment message.

10. The first UE device of claim 9, wherein the PC5-RRC reestablishment message is a RRCReconfiguration Sidelink message including an information element (IE) for indicating that the SL Reconfiguration is a reestablishment of the sidelink communication link.

11. The first UE device of claim 1, wherein the relay link reestablishment message initiates establishment of an alternate communication path for the sidelink communication link to reestablish the sidelink communication link using the PDCP configuration over the alternate communication path.

12. The first UE device of claim 11, wherein the alternate communication path comprises an alternate relay communication link.

13. The first UE device of claim 11, wherein the alternate communication path comprises a direct PC5 communication link between the first UE device and the second UE device.

14. The first UE device of claim 1, wherein the controller is configured to apply a second UE device UE context retained from the communication link to the alternate communication path for the reestablished communication link.

15. The first UE device of claim 1, wherein a first UE device UE context retained from the communication link is applied by the second UE device to the alternate communication path for the reestablished communication link.

16. A relay user equipment (UE) device comprising:
a receiver configured to receive a first Direct Communication Request (DCR) message from a first UE device, the first DCR message identifying a second UE device and indicating the DCR message is a sidelink reestablishment request to reestablish a sidelink communication link between the first UE device and the second UE device, the sidelink communication link having a Packet Data Convergence Protocol (PDCP) configuration;
a transmitter configured to transmit a second DCR message to the second UE device, the second DCR message identifying the first UE device and indicating the DCR message is a sidelink reestablishment request to reestablish the sidelink communication link between the first UE device and the second UE device; and
a controller configured to establish a relay communication link between the first UE device and the second UE device where data is exchanged between the first UE device and the second UE device through relay UE device, the relay communication link having the PDCP configuration of the sidelink communication link.

17. The relay UE device of claim 16, wherein:
the receiver is further configured to receive, from the second UE device, a first DCR response message identifying the first UE device and indicating the first DCR response message is an acceptance of the sidelink reestablishment request to reestablish the sidelink communication link between the first UE device and the second UE device,
the transmitter is further configured to transmit, to the first UE device, a second DCR response message identifying the second UE device and indicating the second DCR response message is acceptance of the sidelink reestablishment request to reestablish the sidelink communication link between the first UE device and the second UE device.
